(19) United States
(12) Patent Application Publication
(10) Pub. No.: US 2025/0240756 A1
(43) Pub. Date: Jul. 24, 2025

(54) TERMINAL AND POSITIONING METHOD

(71) Applicant: NTT DOCOMO, INC., Tokyo (JP)

(72) Inventors: Kousuke Shima, Chiyoda-ku, Tokyo (JP); Tomoya Ohara, Chiyoda-ku, Tokyo (JP); Masaya Okamura, Chiyoda-ku, Tokyo (JP); Syouichi Higuchi, Chiyoda-ku, Tokyo (JP); Takuma Nakamura, Chiyoda-ku, Tokyo (JP); Hiroki Harada, Chiyoda-ku, Tokyo (JP); Daisuke Kurita, Chiyoda-ku, Tokyo (JP); Mayuko Okano, Chiyoda-ku, Tokyo (JP)

(73) Assignee: NTT DOCOMO, INC., Tokyo (JP)

(21) Appl. No.: 18/853,942

(22) PCT Filed: Apr. 14, 2022
(86) PCT No.: PCT/JP2022/017876

§ 371 Date: Oct. 3, 2024

(51) Int. Cl. H04W 64/00; H04L 5/00; H04W 72/0457; H04W 72/51

(52) U.S. Cl. CPC H04W 64/00; H04L 5/0012; H04W 72/0457; H04W 72/51

(57) ABSTRACT

This terminal comprises: a control unit that determines an outside-Bandwidth-Part (BWP) frequency hopping or an inside-BWP frequency hopping that is to be applied to a signal related to a position measurement; a transmission unit that transmits the signal related to the position measurement to a base station; and a reception unit that receives, from the base station, position information calculated at least on the basis of the signal related to the position measurement.

### TECHNICAL FIELD

The present invention relates to a terminal and a positioning method in a wireless communication system.

### BACKGROUND ART

In the 3GPP (3rd Generation Partnership Project), a wireless communication method called 5G or NR (New Radio) (hereinafter, the wireless communication method will be referred to as “5G” or “NR”) is being discussed in order to further increase a capacity of the system, further increase a data transmission speed, and further reduce a delay in a wireless communication area, and the like. In order to meet the requirements of a high-capacity system in NR, a high data transmission rate, low delay, simultaneous connection of a plurality of terminals, low cost, power saving, and the like, various wireless technologies and network architectures are being discussed (for example, non-patent document 1).

Furthermore, in 3GPP standardization, as a Reduced Capability (reduced capability) NR device, a new device type (hereinafter, also referred to as “RedCapUE”) having lower cost and complexity than an eMBB (enhanced Mobile Broadband: enhanced mobile broadband) device or a URLLC (Ultra-Reliable and Low Latency Communications: ultra-reliable and low latency communication) device is being discussed. In addition, RedCapUE is also considering supporting half-duplex frequency division duplex (HD-FDD) to reduce complexity.

### CITATION LIST

### Non Patent Literature

Non Patent Literature 1: 3GPP TS 38.300 V16.8.0 (2021-12)
Non Patent Literature 2: 3GPP TS 38.305 V16.7.0 (2021-12)
Non Patent Literature 3: 3GPP TS 38.455 V16.6.0 (2021-12)
Non Patent Literature 4: 3GPP TS 37.355 V16.7.0 (2021-12)
Non Patent Literature 5: 3GPP TS 23.032 V16.1.0 (2021-12)
Non Patent Literature 6: 3GPP TS 38.215 V16.4.0 (2020-12)
Non Patent Literature 7: 3GPP TS 38.331 V16.7.0 (2021-12)
Non Patent Literature 8: 3GPP TS 38.211 V16.8.0 (2021-12)

### SUMMARY OF INVENTION

### Technical Problem

In NR, enhancement of positioning of a user equipment (UE) is being studied. Further, positioning for RedCapUE is being studied. Since RedCapUE uses a narrowband compared to a normal UE, it is assumed that the accuracy of positioning using a reference signal is reduced.

The present invention has been made in view of the above problems, and an object of the present invention is to perform positioning using a reference signal in a wireless communication system in a wideband.

### Solution to Problem

According to the disclosed technique, a terminal is provided. The terminal includes a control unit configured to determine frequency hopping outside a Bandwidth Part (BWP) or frequency hopping inside the BWP to be applied to a signal related to positioning; a transmission unit configured to transmit, to a base station, the signal related to positioning; and a reception unit configured to receive, from the base station, at least position information calculated based on the signal related to positioning.

### Advantageous Effects of Invention

According to the disclosed technique, it is possible to perform positioning using a reference signal in a wideband in a wireless communication system.

### BRIEF DESCRIPTION OF DRAWINGS

FIG. 1 is a diagram illustrating a wireless communication system.

FIG. 2 is a diagram illustrating an example (1) of positioning.

FIG. 3 is a diagram illustrating an example of measuring DL-RSTD.

FIG. 4 is a diagram illustrating an example of measuring UL-RTOA.

FIG. 5 is a diagram illustrating an example (2) of positioning.

FIG. 6 is a diagram illustrating an example of measuring RTT.

FIG. 7 is a diagram illustrating an example of frequency hopping according to an embodiment of the present invention.

FIG. 8 is a diagram illustrating an example of frequency hopping of an SRS for MIMO.

FIG. 9 is a diagram illustrating an example of frequency hopping of an SRS for positioning according to the embodiment of the present invention.

FIG. 10 is a diagram illustrating an example of frequency hopping outside a BWP of an SRS for positioning according to the embodiment of the present invention.

FIG. 11 is a diagram illustrating an example (1) of inter-slot frequency hopping of an SRS for positioning according to the embodiment of the present invention.

FIG. 12 is a diagram illustrating an example (2) of inter-slot frequency hopping of an SRS for positioning according to the embodiment of the present invention.

FIG. 13 is a diagram illustrating an example (1) of intra-slot frequency hopping of an SRS for positioning according to the embodiment of the present invention.

FIG. 14 is a diagram illustrating an example (2) of intra-slot frequency hopping of an SRS for positioning according to the embodiment of the present invention.

FIG. 15 is a diagram illustrating an example (1) of frequency hopping of an SRS inside the BWP for positioning according to the embodiment of the present invention.

FIG. 16 is a diagram illustrating an example (2) of frequency hopping of an SRS inside the BWP for positioning according to the embodiment of the present invention.

FIG. 17 is a diagram illustrating an example of a functional configuration of a base station 10 according to the embodiment of the present invention.

FIG. 18 is a diagram illustrating an example of a functional configuration of a terminal 20 according to the embodiment of the present invention.

FIG. 19 is a diagram illustrating an example of a hardware configuration of the base station 10 or the terminal 20 according to the embodiment of the present invention.

FIG. 20 is a diagram illustrating an example of a configuration of a vehicle 2001 according to the embodiment of the present invention.

### DESCRIPTION OF EMBODIMENTS

Hereinafter, an embodiment of the present invention will be described with reference to the drawings. Note that the embodiment described below is an example, and the embodiment to which the present invention is applied is not limited to the following embodiment.

In the operation of a wireless communication system of the embodiment of the present invention, an existing technology is appropriately used. The existing technology is, for example, existing LTE, but the present invention is not limited to the existing LTE. In addition, the term “LTE” used in the present specification has a broad meaning including LTE-Advanced, systems subsequent to LTE-Advanced (for example, NR), and a wireless local area network (LAN), unless otherwise specified.

In the embodiment of the present invention, a duplex system may be a time division duplex (TDD) system, a frequency division duplex (FDD) system, or other systems (for example, flexible duplex and the like).

In addition, in the embodiment of the present invention, meaning of a radio parameter or the like being “set (configured)” may indicate that a predetermined value is set in advance (pre-configured), or that a radio parameter indicated by a base station 10 or a terminal 20 is set.

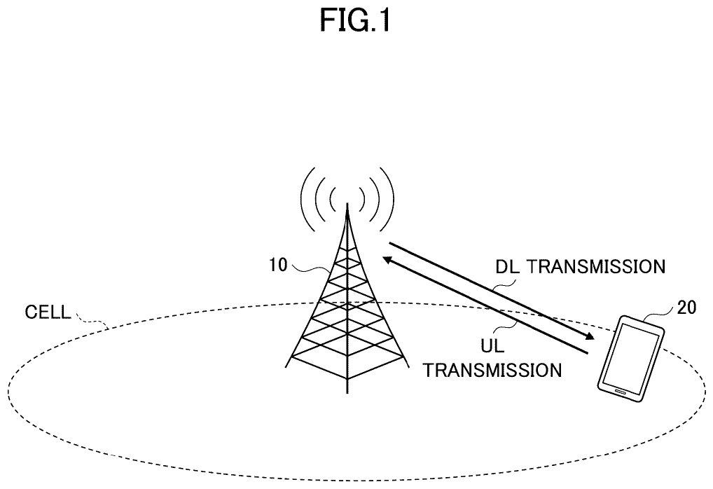

FIG. 1 is a diagram illustrating a wireless communication system. As illustrated in FIG. 1, the wireless communication system according to the embodiment of the present invention includes a base station 10 and a terminal 20. Although one base station and one terminal are illustrated in FIG. 1, the drawing is an example, and a plurality of base stations 10 and a plurality of terminals 20 may be provided.

The base station 10 is a communication device that provides one or more cells and performs wireless communication with the terminal 20. Physical resources of a radio signal are defined in a time domain and a frequency domain, the time domain may be defined by the number of orthogonal frequency division multiplexing (OFDM) symbols, and the frequency domain may be defined by the number of sub-carriers or the number of resource blocks. In addition, a transmission time interval (TTI) in the time domain may be a slot, or the TTI may be a sub-frame.

The base station 10 transmits a synchronization signal and system information to the terminal 20. The synchronization signal is, for example, an NR-PSS and an NR-SSS. The system information is transmitted through, for example, NR-PBCH and is also referred to as indication information. The synchronization signal and the system information may be referred to as an SS/PBCH block (SSB). As illustrated in FIG. 1, the base station 10 transmits a control signal or data to the terminal 20 through a downlink (DL) and receives a control signal or data from the terminal 20 through an uplink (UL). Both the base station 10 and the terminal 20 can transmit and receive a signal by performing beamforming. In addition, both the base station 10 and the terminal 20 can apply communication based on multiple input multiple output (MIMO) to the DL or the UL. In addition, both the base station 10 and the terminal 20 may perform communication via a secondary cell (SCell) and a primary cell (PCell) by carrier aggregation (CA). Furthermore, the terminal 20 may perform communication via a primary cell of the base station 10 and a primary secondary cell group cell (primary SCG cell, PSCell) of another base station 10 by dual connectivity (DC).

The terminal 20 is a communication device having a wireless communication function such as a smartphone, a mobile phone, a tablet, a wearable terminal, or a machine-to-machine (M2M) communication module. As illustrated in FIG. 1, the terminal 20 uses various communication services provided by a wireless communication system by receiving a control signal or data from the base station 10 through the DL and transmitting a control signal or data to the base station 10 through the UL. In addition, the terminal 20 receives various reference signals transmitted from the base station 10 and measures a propagation path quality based on a reception result of the reference signals. Note that the terminal 20 may be referred to as UE, and the base station 10 may be referred to as gNB.

In addition, in LTE or NR, a carrier aggregation function using a broadband to secure data resources is supported. In the carrier aggregation function, a plurality of component carriers is bundled, thereby making it possible to secure broadband data resources. For example, a 100 MHz width may be used by bundling a plurality of 20 MHz bandwidths.

Furthermore, in 3GPP standardization, as a Reduced Capability (reduced capability) NR device, a new device type (hereinafter, also referred to as “RedCapUE”) having lower cost and complexity than an eMBB (enhanced Mobile Broadband: enhanced mobile broadband) device or a URLLC (Ultra-Reliable and Low Latency Communications: ultra-reliable and low latency communication) device is being discussed.

For example, a RedCapUE may have a small maximum supported bandwidth. For example, in frequency range 1 (FR1), RedCapUE may have a maximum bandwidth of 20 MHz during and after initial access. For example, in frequency range 2 (FR2), RedCapUE may have a maximum bandwidth of 100 MHz during and after initial access.

For example, a RedCapUE may support a small number of reception branches. For example, the RedCapUE may support one or two reception branches. In addition, the RedCapUE may support a small maximum number of MIMO layers. For example, the RedCapUE may support one or two MIMO layers. In addition, the RedCapUE may support a small modulation order. For example, in RedCapUE, support of quadrature amplitude modulation (256-QAM) in FR1 may be optional.

In addition, in order to reduce complexity, it is considered that RedCapUE supports half-duplex frequency division duplex (HD-FDD). In frequency division duplex (full-duplex FDD), a DL carrier and a UL carrier are arranged at different frequencies, and can be transmitted and received simultaneously. On the other hand, in HD-FDD (half-duplex frequency division duplex), a DL carrier and a UL carrier are arranged in different frequencies, and cannot be transmitted and received simultaneously, and a DL/UL switching time is required. The HD-FDD can eliminate the duplexer and instead use a switch and an additional filter.

Positioning of the terminal 20 by location management function (LMF) in the Uu interface of 3GPP Release 16 or 17 is executed by methods of the following 1) to 3) (refer to Non Patent Literature 2, Non Patent Literature 3, and Non patent Literature 4).
1) Method based on DL-time difference of arrival (TDOA)
2) Method based on UL-TDOA
3) Method based on multiple round trip time (RTT)

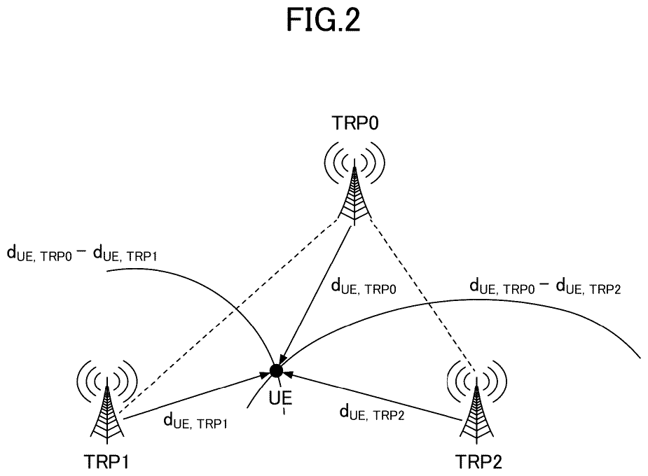

FIG. 2 is a diagram illustrating an example (1) of positioning. As illustrated in FIG. 2, position information of the UE may be calculated based on the DL-TDOA. The position of the UE may be estimated based on a DL-received signal time difference (RSTD) in which the UE measures DL radio signals transmitted from a plurality of NR TRPs. For the estimation, the geographical position of the TRP and the DL transmission timing at the TRP may be used. Furthermore, the position of the UE may be estimated based on reference signal received power (RSRP) of DL-positioning reference signal (PRS) in addition to DL-RSTD.

In the method based on DL-TDOA, the position of the UE may be calculated in the following procedure.
1) The gNB transmits DL-PRS from each TRP to the UE
2) The UE reports the DL-RSTD which is the measurement result to GW and/or gNB and/or LMF via LTE positioning protocol (LPP)
3) The gNB reports timing information related to the TRP to the LMF via NR Positioning Protocol A (NRPPa)
4) Based on the above-described information reported from the UE and the gNB, the LMF calculates the UE position

For example, as illustrated in FIG. 2, a delay between the UE and a TRP0, a delay between the UE and a TRP1, and a delay between the UE and a TRP2 may be measured, and the position of the UE may be calculated based on a geographical position and a DL transmission timing of each TRP.

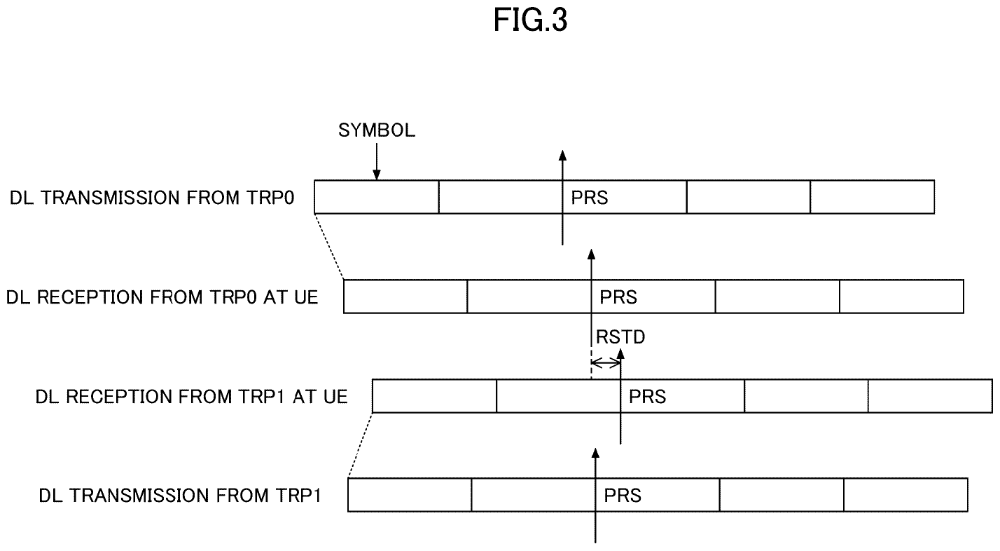

FIG. 3 is a diagram illustrating an example of measuring DL-RSTD. Hereinafter, “and/or” is also referred to as “/”. As illustrated in FIG. 3, DL-RSTD may refer to a time difference measured by the UE between a reception start time point of a DL sub-frame of a reference TRP (TRP0 in FIG. 3) and a reception start time point of a DL sub-frame of another TRP. By detecting the DL-PRS, the start of the sub-frame may be determined.

A transmission timing of each TRP may not be uniform.

Regarding the calculation of the UE position by DL-TDOA, information indicated in the following 1) to 5) may be reported from the UE to GW/gNB/LMF.
1) Physical cell ID (PCI), global cell ID (GCI), and TRP-ID in each measurement
2) DL-RSTD measurement result
3) DL-PRS-RSRP measurement result
4) Time of measurement (time stamp)
5) Quality of each measurement

Regarding the calculation of the UE position by DL-TDOA, the information indicated in the following 1) to 6) may be reported from the gNB to the LMF.
1) PCI, GCI, and TRP-ID of the TRP controlled by the gNB
2) Timing information of the TRP controlled by the gNB
3) DL-PRS setting of the TRP controlled by the gNB
4) Information related to SSB of the TRP controlled by the qNB, for example, the time and frequency resources of the SSB
5) Information related to spatial direction of DL-PRS of the TRP controlled by the gNB
6) Information related to geographic coordinates of the TRP controlled by the gNB

The DL-RSTD may be defined as a time difference measured by the UE between a reception start time point of the DL sub-frame of the reference TRP and a reception start time point of the DL sub-frame of another TRP. A plurality of DL-PRS resources may be used to determine a reception start time point of a sub-frame.

As the report of timing information related to the TRP controlled by the gNB, SFN initialization time of the TRP may be reported. The SFN initialization time is a time at which SFN0 is started.

As the report of information related to the geographical coordinates of the TRP controlled by the gNB, a point on an ellipsoid having altitude and an ellipse indicating a range of error may be reported (refer to Non Patent Literature 5). For example, latitude, longitude, altitude, altitude direction, altitude error range, and the like may be reported.

As illustrated in FIG. 2, position information of the UE may be calculated based on the UL-TDOA. The position of the UE may be estimated based on UL-relative time of arrival (RTOA) in which a plurality of NR TRPs measure UL radio signals transmitted from the UE. For the estimation, other pieces of setting information may be used. Further, the position of the UE may be estimated based on RSRP of a UL-sounding reference signal (SRS) in addition to the UL-RTOA.

In the method based on UL-TDOA, the position of the UE may be calculated in the following procedure.
1) The UE transmits SRS to a plurality of TRPs
2) The gNB reports measurement results including UL-RTOA and geographic coordinates of the TRP to the LMF via the NRPPa
3) Based on the information reported by the gNB, the LMF calculates the position of the UE

For example, as illustrated in FIG. 2, an RTOA from the UE to the TRP0, an RTOA from the UE to the TRP1, and an RTOA from the UE to the TRP2 may be measured, and the position of the UE may be calculated based on the geographical position and a UL transmission timing of each TRP.

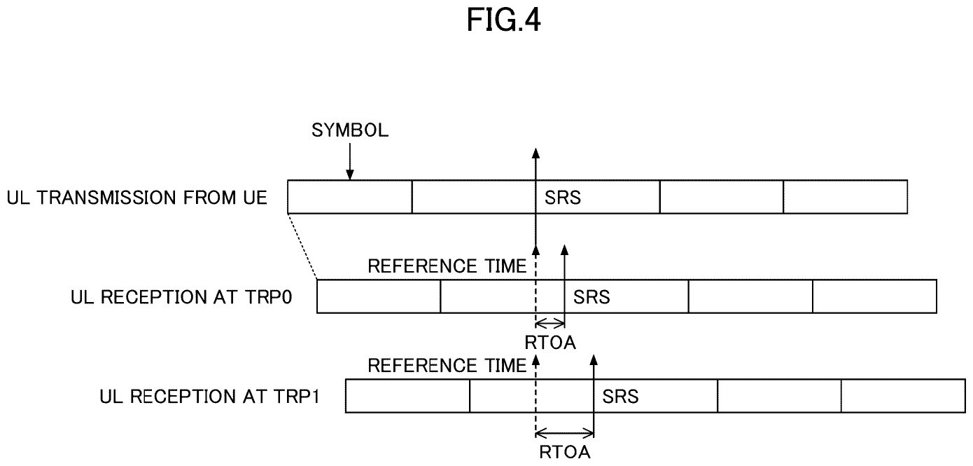

FIG. 4 is a diagram illustrating an example of measuring UL-RTOA. As illustrated in FIG. 4, the UL-RTOA may refer to a time difference between a reception start time point of a UL sub-frame including the SRS of the TRP and an RTOA reference time at which the UL is transmitted.

Regarding the calculation of the UE position by the UL-TDOA, information indicated in the following 1) to 9) may be reported from the gNB to the LMF.
1) PCI, GCI, and TRP-ID of the TRP controlled by the gNB
2) Information related to the SSB of the TRP controlled by the gNB, for example, the time and frequency resources of the SSB
3) Information related to geographic coordinates of the TRP controlled by the gNB
4) NR cell global identifier (NCGI) and TRP-ID of measurement
5) UL-RTOA
6) RSRP of UL-SRS
7) Time of measurement
8) Quality of each measurement
9) Information related to beam of each measurement

The UL-RTOA may be defined as a time difference between a reception start time point of the UL sub-frame including the SRS at the TRP and an RTOA reference time at which the UL is transmitted. The gNB may report the geographical coordinates of the TRP to the LMF via the NRPPa.

FIG. 5 is a diagram illustrating an example (2) of positioning. As illustrated in FIG. 5, the position information of the UE may be calculated based on a plurality of RITs. The position of the UE may be estimated based on UE/gNB reception-transmission time difference measurement using DL-PRS and UL-SRS. For the estimation, DL-PRS-RSRP and UL-SRS-RSRP may be used. The LMF may determine the RTT using the UE/gNB reception-transmission time difference measurement.

In the method based on the multi-RIT, the position of the UE may be calculated in the following procedure.
1) The gNB transmits DL-PRS from each TRP to the UE
2) The UE transmits SRS to a plurality of TRPs
3) The UE reports a UE reception-transmission time difference to the GW and/or the qNB and/or the LMF via the LPP
4) The gNB reports a gNB reception-transmission time difference to the LMF via the NRPPa
5) Based on the information reported from the UE and the gNB, the LMF calculates the position of the UE

For example, as illustrated in FIG. 5, an RTT between the UE and the TRP0, an RTT between the UE and the TRP1, and an RIT between the UE and the TRP2 may be measured, and the position of the UE may be calculated based on the geographical position of each TRP.

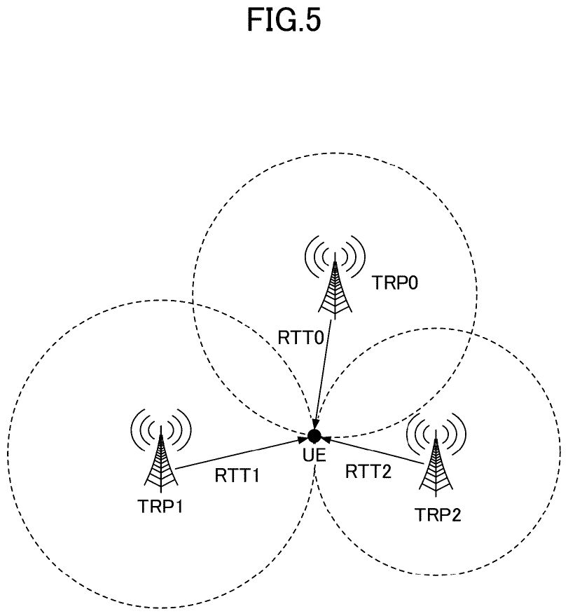

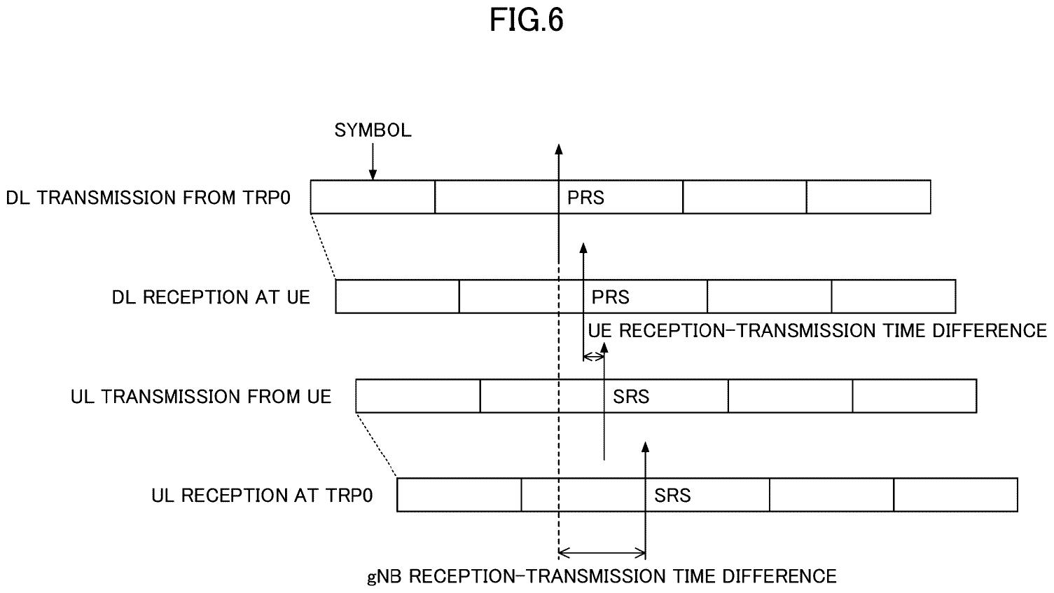

FIG. 6 is a diagram illustrating an example of measuring the RTT. As illustrated in FIG. 6, the UE reception-transmission time difference may refer to a time difference between a timing of receiving the DL sub-frame from the TRP and a timing of transmitting the UL sub-frame. In addition, as illustrated in FIG. 6, the gNB reception-transmission time difference may refer to a time difference between a timing at which the TRP receives the UL sub-frame and a timing at which the TRP transmits the DL sub-frame.

Regarding the calculation of the UE position by the plurality of RITs, information indicated in the following 1) to 5) may be reported from the UE to the GW/gNB/LMF.
1) PCI, GCI and TRP-ID in each measurement
2) DL-PRS-RSRP measurement result
3) UE reception-transmission time difference measurement result
4) Time of measurement
5) Quality of each measurement

Regarding the calculation of the UE position by the RTT, the information indicated in the following 1) to 9) may be reported from the gNB to the LMF.
1) PCI, GCI, and TRP-ID of the TRP controlled by the gNB
2) Timing information of the TRP controlled by the gNB
3) DL-PRS setting of the TRP controlled by the gNB
4) Information related to SSB of the TRP controlled by the qNB, for example, the time and frequency resources of the SSB
5) Information related to spatial direction of DL-PRS of the TRP controlled by the gNB
6) Information related to geographic coordinates of the TRP controlled by the gNB
7) NCGI and TRP-ID of measurement
8) gNB reception-transmission time difference
9) RSRP of UL-SRS
10) UL-angle of arrival (AoA), for example, azimuth and elevation
11) Time of measurement
12) Quality of measurement
13) Information related to beam of measurement

Note that definitions of the UE reception-transmission time difference and the gNB reception-transmission time difference may be referred from Non Patent Literature 6. Similar to DL-RSTD, the geographical coordinates of the TRP may be reported.

As described above, in the positioning by the Uu interface, the positioning method by DL-TDOA, UL-TDOA, and multi-RTT using RSTD, RTOA, and reception-transmission time difference indicating a propagation delay between the UE and the TRP, respectively, has been applied.

Here, enhancement of positioning of a UE in NR is being studied. Further, positioning for RedCapUE is being studied. Further, further reduction of bandwidth is being considered for RedCapUE.

Positioning for RedCapUE is at the stage of performance evaluation, and specific enhancement measures are being studied. For example, since the positioning accuracy is reduced in a narrowband, it is required to ensure the positioning accuracy in a narrowband. In addition, for example, since available resources are limited in a narrowband, optimization of resource mapping is required. Further, for example, a mapping pattern different from that of the SRS for MIMO may be used for the SRS for positioning. Note that the embodiment of the present invention is not limited to the RedCapUE, and may be applied to a normal UE.

In the existing technical specifications, the SRS for MIMO supports frequency hopping as in the RRC information element “SRS-Resource” illustrated below (see Non-Patent Document 7).

```
SRS-Resource ::=  SEQUENCE {
  srs-ResourceId SRS-ResourceId,
[...]
  resourceMapping SEQUENCE {
    startPosition INTEGER (0..5),
    nrofSymbols ENUMERATED {n1, n2,
n4},
    repetitionFactor ENUMERATED {n1, n2,
n4},
  },
  freqDomainPosition INTEGER (0..67),
  freqDomainShift INTEGER (0..268),
  freqHopping SEQUENCE {
    c-SRS INTEGER (0..63),
    b-SRS INTEGER (0..3),
    b-hop  INTEGER (0..3)
  },
[...]
  [[
  resourceMapping-r16 SEQUENCE {
    startPosition-r16 INTEGER (0..13),
    nrofSymbols-r16  ENUMERATED {n1, n2,
n4},
    repetitionFactor-r16 ENUMERATED {n1, n2,
n4},
  } OPTIONAL -- Need R
  ]]
}
```

On the other hand, in the SRS for positioning, frequency hopping is not specified.

Therefore, the terminal 20 may assume that SRS frequency hopping is applied to SRS. The terminal 20 may also assume that frequency hopping outside the BWP be applied to SRS (SRS frequency hopping outside BWP). The terminal 20 may also assume that frequency hopping inside the BWP be applied to SRS (SRS frequency hopping inside BWP).

In the embodiment of the present invention, the term “SRS” includes both SRS for MIMO and SRS for positioning. Further, the embodiment of the present invention is not limited to the RedCapUE positioning, and may be applied to a general NR terminal positioning (UE NR positioning).

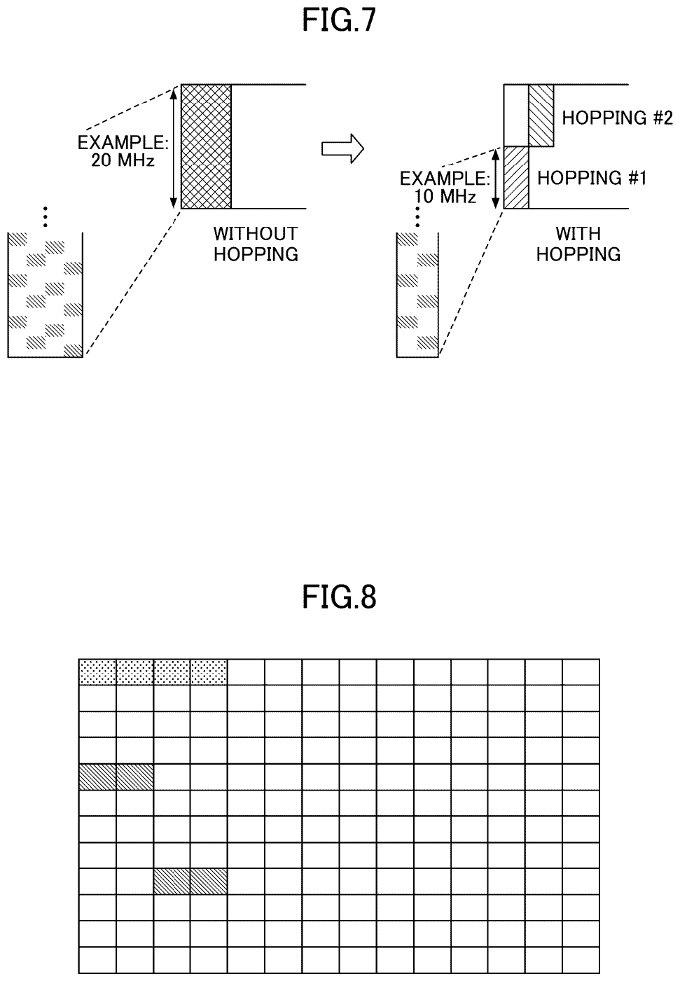

FIG. 7 is a diagram illustrating an example of frequency hopping in the embodiment of the present invention. FIG. 7 illustrates an example of SRS without frequency hopping and an example of SRS with frequency hopping. Since the RedCapUE is limited in terms of hardware due to size constraints, it is difficult to increase the antenna gain.

Therefore, frequency hopping as illustrated in FIG. 7 may be introduced for RedCapUE. By introducing the frequency hopping outside the BWP, it is possible to increase transmission power per RE (Resource Element) and to execute measurement with a bandwidth equivalent to that at the time of non-hopping. Thus, the positioning accuracy can be secured. Further, by introducing the frequency hopping inside the BWP, it is possible to perform measurement with a reduced bandwidth used for the SRS. This makes it possible to secure resources.

FIG. 8 is a diagram illustrating an example of frequency hopping of the SRS for MIMO. The parameters related to frequency hopping in FIG. 8 are as follows (see Non-Patent Document 8).
transmissionComb=n4
nrnoSymbols (Ns)=n4
RepeatFactor (R)=n2

As illustrated in FIG. 8, frequency hopping is set by the above parameters such that the number of subcarriers of the transmission comb is 4, the number of symbols is 4, and the number of repetition symbols is 2. Here, while the SRS for MIMO is mapped on the same frequency in a comb structure, the SRS for positioning is mapped in a comb structure and has a RE offset set therein because the positioning is performed using the entire band, and thus hopping pattern design for the SRS for positioning is required.

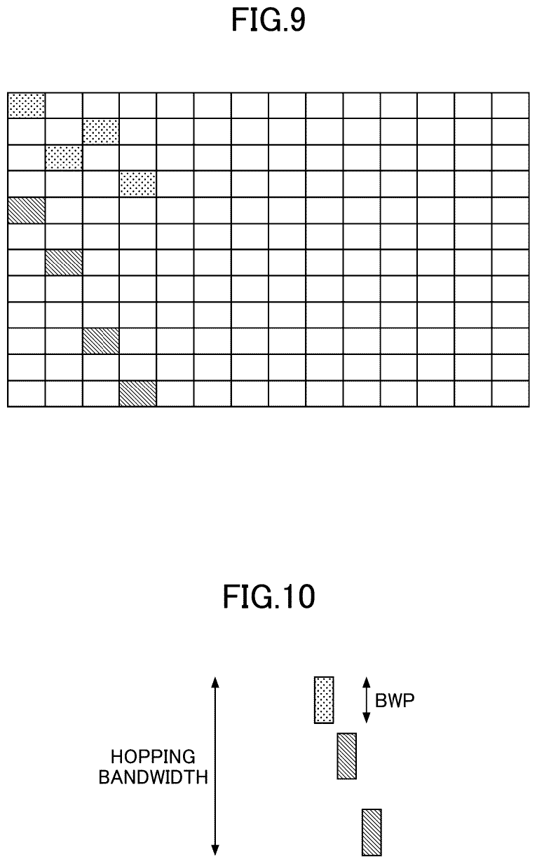

FIG. 9 is a diagram illustrating an example of frequency hopping of the SRS for positioning according to the embodiment of the present invention. The terminal 20 and the base station 10 may assume that the hopping pattern is set with the SRS defined by the same offset set as a unit, based on the symbol where the offset k_{offset}^{l′} (see Non-Patent Document 8) of the SRS for positioning is 0. The parameters related to frequency hopping in FIG. 9 are as follows (see Non-Patent Document 8).
transmissionComb=n4
nrnoSymbols (Ns)=n4
RepeatFactor (R)=n2
RE offset={0, 2, 1, 3}

As illustrated in FIG. 9, the frequency hopping is set by the above parameters such that the number of subcarriers of the transmission comb is 4, the number of symbols is 4, the number of repetition symbols is 2, and the RE offset is {0, 2, 1, 3}. For example, the terminal 20 and the base station 10 may assume that the same RE offset is set in the hopping source and the hopping destination, or the terminal 20 and the base station 10 may assume that different RE offsets are set.

For example, the number of repetition symbols R (repetitionFactor (R)) may be set, and the terminal 20 and the base station 10 may assume hopping for every R symbols in the offset set defined by k_{offset}^{l′}

For example, the terminal 20 and the base station 10 may assume any one of intra-slot frequency hopping, inter-slot frequency hopping, or a combination of intra-slot frequency hopping and inter-slot frequency hopping. The terminal 20 and the base station 10 may assume that different parameters are set for the intra-slot frequency hopping and the inter-slot frequency hopping.

For example, the terminal 20 may report the required UE capability to the network. The UE capability may be information indicating whether hopping is supported. Furthermore, the UE capability may include information indicating whether intra-slot frequency hopping and/or inter-slot frequency hopping are/is supported. Furthermore, the UE capability may include information indicating whether to support frequency hopping outside the BWP.

For example, the terminal 20 may assume that the parameters necessary for frequency hopping are configured, updated, and/or indicated by the network via RRC signaling, MAC-CE, and/or DCI. The terminal 20 may request the network to provide parameters necessary for frequency hopping.

The parameters required for the frequency hopping may be at least one of a parameter for determining a hopping destination, a bandwidth for performing hopping, or a length of a time domain of hopping. The default values of the parameters required for the frequency hopping may be defined in the technical specifications or may be set for each UE. The parameters required for such frequency hopping may be different between SRS for MIMO (normal SRS) and SRS for positioning.

For example, the terminal 20 may assume that the intra-slot frequency hopping and/or the inter-slot frequency hopping are/is explicitly configured by the network, or the terminal 20 may implicitly assume the hopping operation according to the configured parameters. For example, the setting may be {activate, deactivate}. For example, when the hopping bandwidth is set to be smaller than the SRS bandwidth, the terminal 20 may assume that the hopping inside the BWP is set. For example, when the hopping bandwidth is set to be larger than the SRS bandwidth, the terminal 20 may assume that the hopping outside the BWP is set.

FIG. 10 is a diagram illustrating an example of frequency hopping outside the BWP of the SRS for positioning according to the embodiment of the present invention. As illustrated in FIG. 10, the terminal 20 may assume frequency hopping outside the BWP in which hopping is performed to the outside of the frequency domain of the BWP. The frequency hopping outside the BWP may be an operation of transmitting the SRS for positioning temporarily in a wideband including the outside of the BWP without changing the BWP. By the frequency hopping outside the BWP, positioning is performed temporarily in a wideband including the outside of the BWP, and the positioning accuracy can be improved.

For example, the frequency hopping outside the BWP may be performed in combination with the frequency hopping inside the BWP. The frequency hopping inside the BWP may be frequency hopping inside the BWP and/or inside the RB, which will be described in detail later.

For example, the terminal 20 and the base station 10 may assume 1) and 2) illustrated below for the RF retuning gap period to perform SRS transmission outside the BWP.

1) Gap setting rules
1-1) The transmission gap may be periodically set at a predetermined timing. The period may be determined by the technical specifications or may be set by the network. Intra-slot gaps and inter-slot gaps may be expected.
1-2) The gap may be set or preset only at the timing when RF retuning is required. The information related to the timing may be requested from the terminal 20 when necessary, or may be expected to be indicated by the network when necessary. Intra-slot gaps and inter-slot gaps may be expected.
2) Gap setting time. A plurality of candidate gap periods may be defined according to the UE capabilities, and which of the candidate gap periods is to be used may be set by the network. The following T₁ and T₂ may be defined independently from the values configured in the PRS.
2-1) As an example, in a low-end UE capable of simultaneously receiving only for a bandwidth as large as the BWP, a longer gap period T₁ necessary for retuning may be set.
2-2) As an example, in a high-end UE that has a reduced BWP from the viewpoint of power consumption, but is capable of simultaneously receiving a wider band as RF, a gap period T₂ shorter than T₁ may be set. Alternatively, the high-end UE may be configured with no gap (T=0).

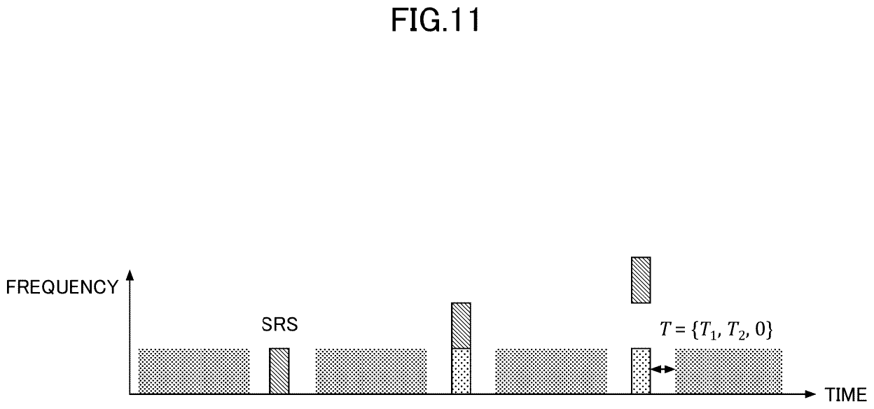

FIG. 11 is a diagram illustrating an example (1) of inter-slot frequency hopping of the SRS for positioning according to the embodiment of the present invention. FIG. 11 illustrates an example in which frequency hopping outside the BWP between slots is set and a gap is periodically set. As described above, the gap period T can be set to any one of {T₁, T₂, 0}.

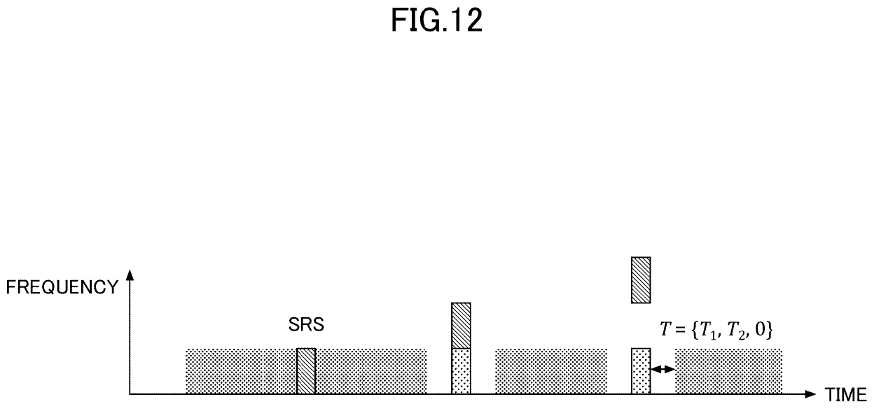

FIG. 12 is a diagram illustrating an example (2) of inter-slot frequency hopping of the SRS for positioning according to the embodiment of the present invention. FIG. 12 illustrates an example in which frequency hopping outside the BWP between slots is set and a gap is set at a timing at which RF retuning is required. As described above, the gap period T can be set to any one of {T₁, T₂, 0}.

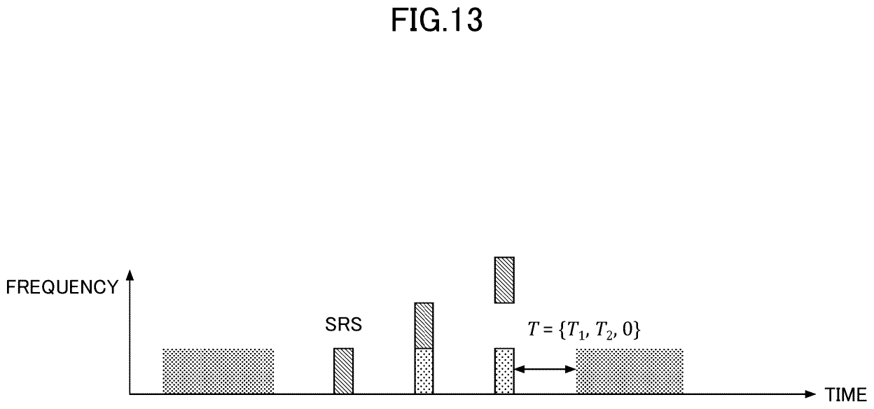

FIG. 13 is a diagram illustrating an example (1) of intra-slot frequency hopping of the SRS for positioning according to the embodiment of the present invention. FIG. 13 illustrates an example in which frequency hopping outside the BWP in a slot is set and a gap is periodically set. As described above, the gap period T can be set to any one of {T₁, T₂, 0}.

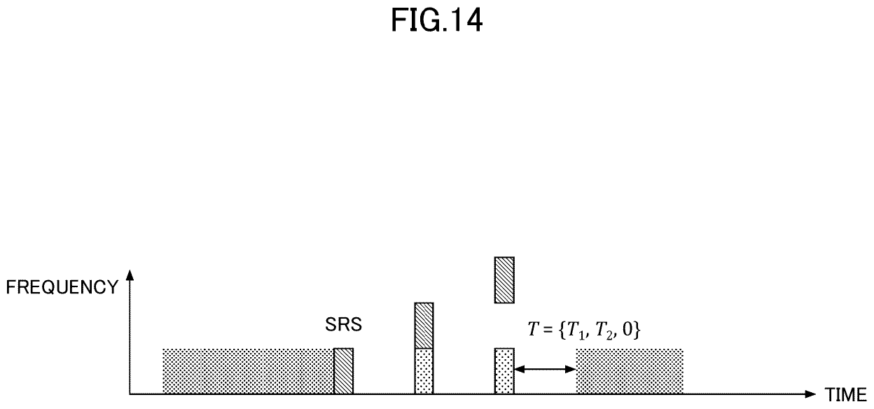

FIG. 14 is a diagram illustrating an example (2) of intra-slot frequency hopping of the SRS for positioning according to the embodiment of the present invention. FIG. 14 illustrates an example in which frequency hopping outside the BWP between slots is set and a gap is set at a timing at which RF retuning is required. As described above, the gap period T can be set to any one of {T₁, T₂, 0}.

For example, in consideration of the effect on the neighbor terminals, scheduling or the like may be performed in advance as described in the following 1) to 4)

1) To avoid interference, the hopping bandwidth and/or timing are/is restricted.
2) The SRS is transmitted only with the SRS resource ID specified by the network.
3) Other terminals may stop transmission by giving priority to the hopping outside the BWP, or may perform transmission only in REs not used by the hopping.
4) When the hopping outside the BWP collides with the neighboring terminal signal, the terminal 20 may assume that the retransmission of the SRS will be requested by the network.

For example, when there is another signal to be transmitted or received in the BWP at the timing of the retuning gap, the priority may be set as illustrated in the following 1) to 3).

1) Another signal is prioritized and SRS hopping is not performed.
2) Another signal is prioritized and the SRS transmission is performed by using the hopping inside the BWP.
3) The SRS is prioritized, the RF retuning gap is set and then the hopping outside the BWP is performed, and another signal is not transmitted and received.

For example, a simple hopping pattern may be set in consideration of narrowband communication. For example, a table indicating a plurality of candidate hopping bandwidths and/or a hopping rule that is easy to process may be defined by categorizing the candidate hopping bandwidths into categories such as normal UE, high-end RedCapUE, and low-end RedCapUE.

For example, parameter information such as hopping bandwidth may be shared between UL (SRS) and DL (PRS). The positioning accuracy may be corrected by UL positioning and DL positioning (multi-RTT).

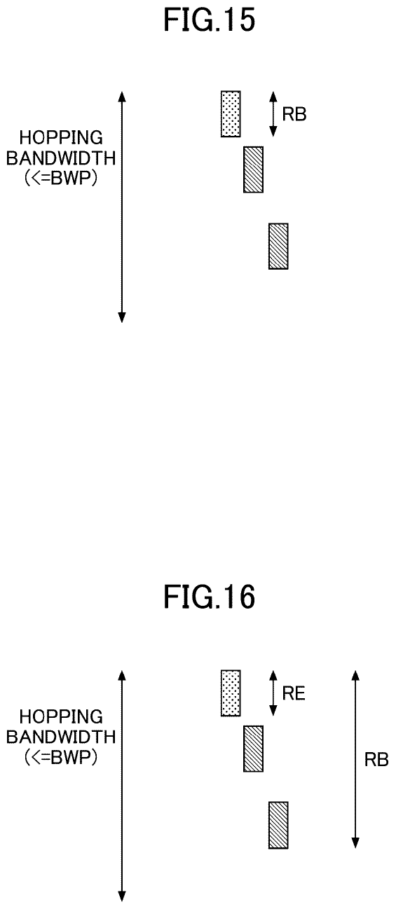

FIG. 15 is a diagram illustrating an example (1) of frequency hopping of an SRS inside the BWP for positioning according to the embodiment of the present invention. As illustrated in FIG. 15, the terminal 20 may assume frequency hopping inside the BWP in which hopping is performed inside the BWP frequency domain. The SRS may be mapped to only a part of the BWP, and the remaining frequency domain may be covered by the hopping, so that the resources inside the BWP may be effectively used. The example illustrated in FIG. 15 is an example of hopping in RB units inside the BWP.

FIG. 16 is a diagram illustrating an example (2) of frequency hopping of an SRS inside the BWP for positioning according to the embodiment of the present invention. The example illustrated in FIG. 16 is an example of hopping in units of REs in the RB in the BWP.

For example, a simple hopping pattern may be set in consideration of narrowband communication. For example, a table indicating a plurality of candidate hopping bandwidths and/or a hopping rule that is easy to process may be defined by categorizing the candidate hopping bandwidths into categories such as normal UE, high-end RedCapUE, and low-end RedCapUE.

For example, parameter information such as hopping bandwidth may be shared between UL (SRS) and DL (PRS). The positioning accuracy may be corrected by UL positioning and DL positioning (multi-RTT).

Note that “SRS” may be replaced with “SRS for MIMO”, “SRS for positioning”, or the like.

The “network” may be replaced with “gNB”, “TRP”, “LMF”, or the like.

Note that “RF retuning” may be replaced with “RF switching”, “RF adjustment”, or the like.

Note that “set by the network” may be replaced with “set by RRC signaling”, “activated/deactivated/updated by MAC-CE”, “indicated by DCI”, and like.

According to the above-described embodiment, the terminal 20 can improve the positioning accuracy by the positioning in a wideband. In addition, the terminal 20 can effectively utilize the resources in the BWP by performing frequency hopping on the reference signal mapped to a part of the BWP.

That is, in the wireless communication system, positioning using the reference signal can be performed in a wideband.

### (Device Configuration)

Next, functional configuration examples of the base station 10 and the terminal 20 that execute the processing and operation described above will be described. The base station 10 and the terminal 20 include a function of implementing the above-described embodiment. However, each of the base station 10 and the terminal 20 may have only a part of functions in the embodiment.

### <Base Station 10>

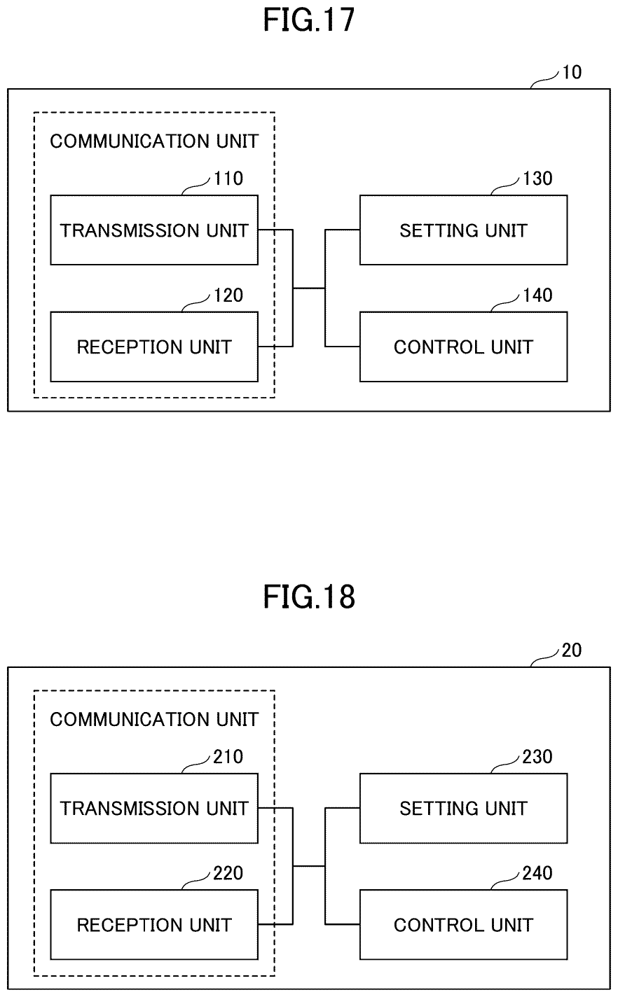

FIG. 17 is a diagram illustrating an example of a functional configuration of the base station 10. As illustrated in FIG. 17, the base station 10 includes a transmission unit 110, a reception unit 120, a setting unit 130, and a control unit 140. The functional configuration illustrated in FIG. 17 is merely an example. As long as the operation according to the embodiment of the present invention can be executed, the functional classification and the name of the functional units may be freely selected.

The transmission unit 110 has a function of generating a signal to be transmitted to the terminal 20 side and wirelessly transmitting the signal. The reception unit 120 has a function of receiving various signals transmitted from the terminal 20 and acquiring, for example, information of an upper layer from the received signals. In addition, the transmission unit 110 has a function of transmitting NR-PSS, NR-SSS, NR-PBCH, a DL/UL control signal, a DL reference signal, and the like to the terminal 20.

The setting unit 130 stores setting information set in advance and various types of setting information to be transmitted to the terminal 20 in a storage device, and reads the setting information from the storage device as necessary. A content of the setting information is, for example, information related to setting of the D2D communication.

As described in the embodiment, the control unit 140 performs processing related to setting for the terminal 20 to perform the D2D communication. Furthermore, the control unit 140 transmits scheduling of the D2D communication and the DL communication to the terminal 20 via the transmission unit 110. Furthermore, the control unit 140 receives information regarding HARQ responses of the D2D communication and the DL communication from the terminal 20 via the reception unit 120. The functional unit related to signal transmission in the control unit 140 may be included in the transmission unit 110, and the functional unit related to signal reception in the control unit 140 may be included in the reception unit 120.

### <Terminal 20>

FIG. 18 is a diagram illustrating an example of a functional configuration of the terminal 20. As illustrated in FIG. 18, the terminal 20 includes a transmission unit 210, a reception unit 220, a setting unit 230, and a control unit 240. The functional configuration illustrated in FIG. 18 is merely an example. As long as the operation according to the embodiment of the present invention can be executed, the functional classification and the name of the functional units may be freely selected.

The above-described LTE-SL transmission/reception mechanism (module) and the above-described NR-SL transmission/reception mechanism (module) may separately include the transmission unit 210, the reception unit 220, the setting unit 230, and the control unit 240.

The transmission unit 210 generates a transmission signal from transmission data and wirelessly transmits the transmission signal. The reception unit 220 wirelessly receives various signals and acquires a signal of an upper layer from the received signals of a physical layer. Furthermore, the reception unit 220 has a function of receiving NR-PSS, NR-SSS, NR-PBCH, a DL/UL/SL control signal, a reference signal, and the like transmitted from the base station 10. Furthermore, for example, the transmission unit 210 transmits a physical sidelink control channel (PSCCH), a physical sidelink shared channel (PSSCH), a physical sidelink discovery channel (PSDCH), a physical sidelink broadcast channel (PSBCH), or the like to the other terminal 20 as the D2D communication, and the reception unit 220 receives PSCCH, PSSCH, PSDCH, PSBCH, or the like from the other terminal 20.

The setting unit 230 stores various types of setting information received from the base station 10 or the terminal 20 by the reception unit 220 in a storage device, and reads the setting information from the storage device as necessary. The setting unit 230 also stores setting information set in advance. A content of the setting information is, for example, information related to setting of the D2D communication.

As described in the embodiment, the control unit 240 controls the D2D communication for establishing an RRC connection with another terminal 20. Furthermore, the control unit 240 performs processing related to a power saving operation. Furthermore, the control unit 240 performs processing related to HARQ of the D2D communication and the DL communication. Furthermore, the control unit 240 transmits, to the base station 10, information regarding HARQ responses of the D2D communication and the DL communication scheduled from the base station 10 to another terminal 20. Furthermore, the control unit 240 may schedule the D2D communication to another terminal 20. Furthermore, the control unit 240 may autonomously select a resource to be used for the D2D communication from a resource selection window based on a result of sensing, or may execute reevaluation or pre-emption. Furthermore, the control unit 240 performs processing related to power saving in transmission and reception of the D2D communication. Furthermore, the control unit 240 performs processing related to inter-terminal cooperation in the D2D communication. The functional unit related to signal transmission in the control unit 240 may be included in the transmission unit 210, and the functional unit related to signal reception in the control unit 240 may be included in the reception unit 220.

### (Hardware Configuration)

The block diagrams used for the description of the above-described embodiment (FIGS. 17 and 18) illustrate blocks of functional units. The functional blocks (configuration units) are realized by any combination of at least one of hardware and software. A method of implementing each functional block is not particularly limited. That is, each functional block may be implemented by using one physically or logically combined device, or may be implemented by directly or indirectly (for example, by using wired, wireless, or the like) connecting two or more physically or logically separated devices to each other and using the plurality of devices. The functional block may be implemented by combining software with the one device or the plurality of devices.

The functions include, but are not limited to, deciding, determining, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating and mapping, assigning, and the like. For example, a functional block (configuration unit) that causes transmission to function is referred to as a transmission unit (transmitting unit) or a transmitter. In any case, as described above, the implementation method is not particularly limited.

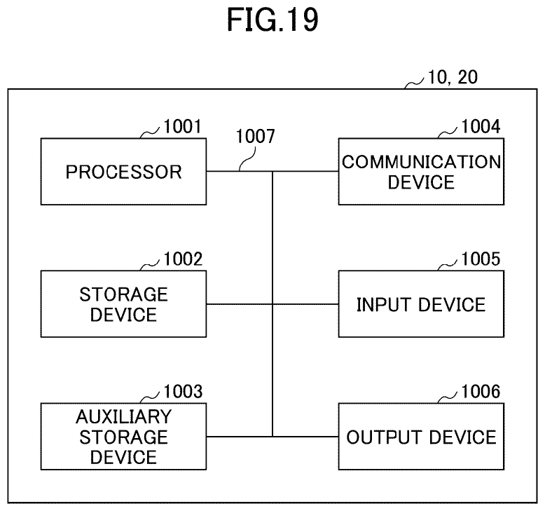

For example, the base station 10, the terminal 20, and the like in the embodiment of the present disclosure may function as a computer that performs processing of a wireless communication method of the present disclosure. FIG. 19 is a diagram illustrating an example of hardware configurations of the base station 10 and the terminal 20 according to the embodiment of the present disclosure. The base station 10 and the terminal 20 described above may be physically configured as a computer device including a processor 1001, a storage device 1002, an auxiliary storage device 1003, a communication device 1004, an input device 1005, an output device 1006, a bus 1007, and the like.

In the following description, the term “device” can be replaced with a circuit, a device, a unit, or the like. The hardware configurations of the base station 10 and the terminal 20 may be configured to include one or more devices illustrated in the drawing, or may be configured without including a part of devices.

Each function in the base station 10 and the terminal 20 is implemented by the processor 1001 performing calculation by loading predetermined software (program) on hardware such as the processor 1001 and the storage device 1002, controlling communication by the communication device 1004, and controlling at least one of reading and writing of data in the storage device 1002 and the auxiliary storage device 1003.

The processor 1001 operates, for example, an operating system to control the entire computer. The processor 1001 may include a central processing unit (CPU) including an interface with a peripheral device, a control device, an arithmetic device, a register, and the like. For example, the control unit 140, the control unit 240, and the like described above may be implemented by the processor 1001.

In addition, the processor 1001 reads a program (a program code), a software module, data, or the like from at least one of the auxiliary storage device 1003 and the communication device 1004 to the storage device 1002, and executes various types of processing according to the program, the software module, the data, or the like. As the program, a program that causes a computer to execute at least part of the operations described in the above-described embodiments is used. For example, the control unit 140 of the base station 10 illustrated in FIG. 17 may be implemented by a control program stored in the storage device 1002 and operated by the processor 1001.

Furthermore, for example, the control unit 240 of the terminal 20 illustrated in FIG. 18 may be implemented by a control program stored in the storage device 1002 and operated by the processor 1001. Although it has been described that the above-described various types of processing are executed by one processor 1001, the various types of processing may be executed simultaneously or sequentially by two or more processors 1001. The processor 1001 may be implemented by one or more chips. The program may be transmitted from a network via an electric communication line.

The storage device 1002 is a computer-readable recording medium, and may be configured with, for example, at least one of a read only memory (ROM), an erasable programmable ROM (EPROM), an electrically erasable programmable ROM (EEPROM), a random access memory (RAM), and the like. The storage device 1002 may be referred to as a register, a cache, a main memory (a main storage device), or the like. The storage device 1002 can store a program (a program code), a software module, and the like that can be executed to implement the communication method according to the embodiment of the present disclosure.

The auxiliary storage device 1003 is a computer-readable recording medium, and may be configured with, for example, at least one of an optical disk such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The above-described storage medium may be, for example, a database including at least one of the storage device 1002 and the auxiliary storage device 1003, a server, or another appropriate medium.

The communication device 1004 is hardware (a transmission/reception device) for performing communication between computers via at least one of a wired network and a wireless network, and is also referred to as, for example, a network device, a network control unit, a network card, a communication module, or the like. The communication device 1004 may be configured with a high-frequency switch, a duplexer, a filter, a frequency synthesizer, and the like to implement, for example, at least one of frequency division duplex (FDD) and time division duplex (TDD). For example, a transmission/reception antenna, an amplifier unit, a transmission/reception unit, a transmission/reception path interface, and the like may be implemented by the communication device 1004. The transmission/reception unit may be implemented such that the transmission unit and the reception unit are physically or logically separated from each other.

The input device 1005 is an input device (for example, a keyboard, a mouse, a microphone, a switch, a button, a sensor, or the like) that receives an input from the outside. The output device 1006 is an output device (for example, a display, a speaker, an LED lamp, and the like) that performs an output to the outside. Note that the input device 1005 and the output device 1006 may be formed to be integrated with each other (for example, a touch panel).

In addition, the respective devices such as the processor 1001 and the storage device 1002 are connected to each other by the bus 1007 for communicating information. The bus 1007 may be configured using a single bus or may be configured using different buses between the devices.

Furthermore, the base station 10 and the terminal 20 may be configured to include hardware such as a microprocessor, a digital signal processor (DSP), an application specific integrated circuit (ASIC), a programmable logic device (PLD), or a field programmable gate array (FPGA), and some or all of the functional blocks may be implemented by the hardware. For example, the processor 1001 may be implemented using at least one of the pieces of hardware.

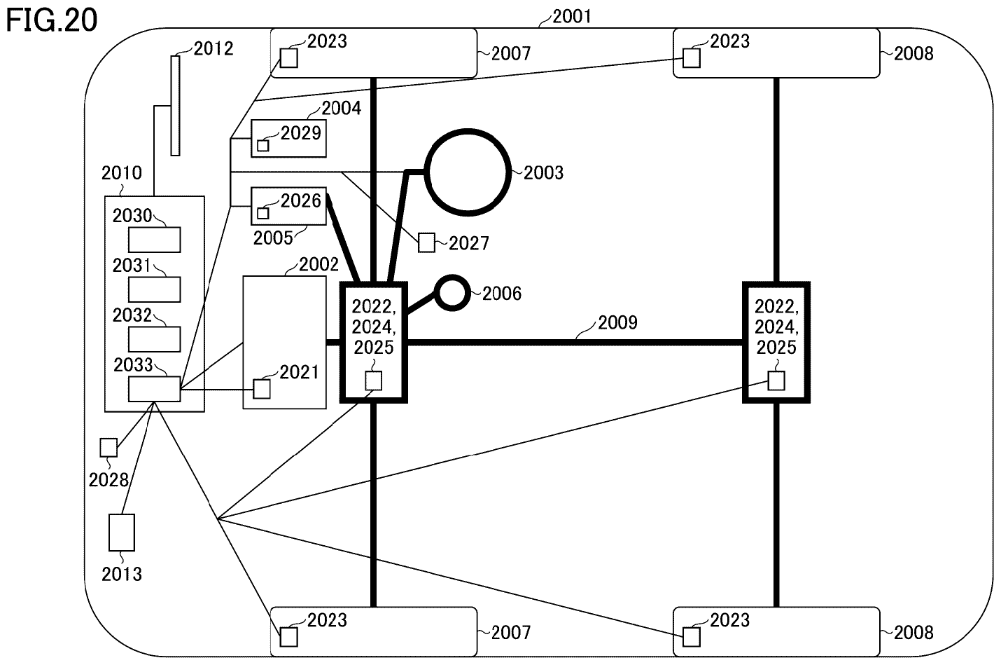

FIG. 20 illustrates a configuration example of a vehicle 2001. As illustrated in FIG. 20, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013. Each aspect/embodiment described in the present disclosure may be applied to a communication device mounted on the vehicle 2001, and for example, may be applied to the communication module 2013.

The drive unit 2002 includes, for example, an engine, a motor, or a hybrid of an engine and a motor. The steering unit 2003 includes at least a steering wheel (also referred to as a handle), and is configured to steer at least one of the front wheel and the rear wheel based on an operation of the steering wheel operated by a user.

The electronic control unit 2010 includes a microprocessor 2031, a memory (ROM, RAM) 2032, and a communication port (IO port) 2033. Signals from various sensors 2021 to 2029 provided in the vehicle 2001 are input to the electronic control unit 2010. The electronic control unit 2010 may be referred to as an electronic control unit (ECU).

Examples of signals from the various sensors 2021 to 2029 include a current signal from the current sensor 2021 that senses the current of the motor, a rotation speed signal of the front wheel and the rear wheel acquired by the rotation speed sensor 2022, an air pressure signal of the front wheel and the rear wheel acquired by the air pressure sensor 2023, a vehicle speed signal acquired by the vehicle speed sensor 2024, an acceleration signal acquired by the acceleration sensor 2025, a depression amount signal of an accelerator pedal acquired by the accelerator pedal sensor 2029, a depression amount signal of a brake pedal acquired by the brake pedal sensor 2026, an operation signal of a shift lever acquired by the shift lever sensor 2027, and a detection signal for detecting an obstacle, a vehicle, a pedestrian, and the like acquired by the object detection sensor 2028.

The information service unit 2012 is configured with various devices for providing (outputting) various types of information such as driving information, traffic information, and entertainment information, such as a car navigation system, an audio system, a speaker, a television, and a radio, and one or more ECUs that control the devices. The information service unit 2012 provides various types of multi-media information and multi-media services to an occupant of the vehicle 2001 using information acquired from an external device via the communication module 2013 or the like. The information service unit 2012 may include an input device (for example, a keyboard, a mouse, a microphone, a switch, a button, a sensor, a touch panel, or the like) that receives an input from the outside, or may include an output device (for example, a display, a speaker, an LED lamp, a touch panel, or the like) that performs an output to the outside.

A driving assistance system unit 2030 is configured with various devices for providing functions of preventing an accident in advance and reducing a driver's driving load, such as a millimeter wave radar, light detection and ranging (LiDAR), a camera, a positioning locator (for example, GNSS or the like), map information (for example, a high definition (HD) map, an autonomous vehicle (AV) map, and the like), a gyro system (for example, an inertial measurement unit (IMU), an inertial navigation system (INS), or the like), an artificial intelligence (AI) chip, and an AI processor, and one or more ECUs that control the devices. The driving assistance system unit 2030 also transmits and receives various types of information via the communication module 2013 to implement a driving assistance function or an automatic driving function.

The communication module 2013 may communicate with the microprocessor 2031 and components of the vehicle 2001 via a communication port. For example, the communication module 2013 transmits and receives, via the communication port 2033, data to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and the sensors 2021 to 2029 provided in the vehicle 2001.

The communication module 2013 is a communication device capable of being controlled by the microprocessor 2031 of the electronic control unit 2010 and capable of communicating with an external device. For example, various types of information are transmitted and received to and from the external device via wireless communication. The communication module 2013 may be provided on the inside or the outside of the electronic control unit 2010. The external device may be, for example, a base station, a mobile station, or the like.

The communication module 2013 may perform transmission at least one of signals from the various sensors 2021 to 2028 described above input to the electronic control unit 2010, information obtained based on the signals, and information based on input from the outside (user) obtained via the information service unit 2012 to an external device via wireless communication. The electronic control unit 2010, the various sensors 2021 to 2028, the information service unit 2012, and the like may be referred to as an input unit that receives an input. For example, the PUSCH transmitted by the communication module 2013 may include information based on the input.

The communication module 2013 receives various types of information (traffic information, signal information, inter-vehicle information, and the like) transmitted from an external device, and displays the information on the information service unit 2012 provided in the vehicle 2001. The information service unit 2012 may be referred to as an output unit that outputs information (e.g., outputs information to a device such as a display, speaker, etc. based on the PDSCH (or data/information decoded from the PDSCH) received by the communication module 2013). The communication module 2013 also stores various types of information received from the external device in the memory 2032 available by the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2029, and the like included in the vehicle 2001.

### Summary of Embodiments

As described above, according to the embodiment of the present invention, a terminal is provided. The terminal includes
a control unit configured to determine frequency hopping outside a Bandwidth Part (BWP) or frequency hopping inside the BWP to be applied to a signal related to positioning;
a transmission unit configured to transmit, to a base station, the signal related to positioning; and
a reception unit configured to receive, from the base station, at least position information calculated based on the signal related to positioning.

With the above configuration, the terminal 20 can improve positioning accuracy by performing positioning in a wideband. In addition, the terminal 20 can effectively utilize the resources in the BWP by performing frequency hopping on the reference signal mapped to a part of the BWP. That is, in the wireless communication system, it is possible to alleviate the deterioration of the accuracy of the positioning using the reference signal.

When the signal related to positioning is transmitted outside the BWP, the control unit may set a periodic gap or a gap only at a timing necessary for radio retuning. With this configuration, the terminal 20 can improve the positioning accuracy by performing the positioning in a wideband.

The control unit may assume different gap lengths for radio retuning based on terminal capabilities. With this configuration, the terminal 20 can improve the positioning accuracy by performing the positioning in a wideband.

The control unit may determine whether to transmit the signal related to positioning based on a priority when a gap for radio retuning overlaps with another signal. With this configuration, the terminal 20 can improve the positioning accuracy by performing the positioning in a wideband.

When applying frequency hopping inside the BWP, the control unit may apply frequency hopping in units of resource blocks or in units of resource elements to the signal related to positioning. With this configuration, the terminal 20 can effectively utilize the resources in the BWP by performing frequency hopping on the reference signals mapped to a part of the BWP.

According to the embodiment of the present invention, a communication method performed by a terminal is provided. The communication method includes determining frequency hopping outside a Bandwidth Part (BWP) or frequency hopping inside the BWP to be applied to a signal related to positioning; transmitting the signal related to positioning to a base station; and receiving, from the base station, at least position information calculated based on the signal related to positioning.

With the above configuration, the terminal 20 can improve positioning accuracy by performing the positioning in a wideband. In addition, the terminal 20 can effectively utilize the resources in the BWP by performing frequency hopping on the reference signal mapped to a part of the BWP. That is, in the wireless communication system, it is possible to alleviate the deterioration of the accuracy of the positioning using the reference signal.

### Supplement to Embodiment

Although the embodiment of the present invention have been described above, the disclosed invention is not limited to such embodiments, and those skilled in the art will understand various modifications, revisions, alternatives, substitutions, and the like. Although the description has been given using specific numerical examples to facilitate understanding of the invention, the numerical values are merely examples, and any appropriate value may be used, unless otherwise specified. The classification of items in the above description is not essential to the present invention, and items described in two or more items may be used in combination as necessary, or items described in one item may be applied to items described in another item (as long as there is no contradiction). A boundary of a functional unit or a processing unit in the functional block diagram does not necessarily correspond to a boundary of a physical component. The operations of the plurality of functional units may be physically performed by one component, or the operation of one functional unit may be physically performed by a plurality of components. In the processing procedure described in the embodiment, the order of the processing may be changed as long as there is no contradiction. For convenience of processing description, the base station 10 and the terminal 20 have been described using a functional block diagram, but such a device may be implemented by hardware, software, or a combination thereof. Software operated by a processor included in the base station 10 according to the embodiment of the present invention, and software operated by a processor included in the terminal 20 according to the embodiment of the present invention may be stored in any appropriate storage medium such as a random access memory (RAM), a flash memory, a read-only memory (ROM), an EPROM, an EEPROM, a register, a hard disk (HDD), a removable disk, a CD-ROM, a database, or a server.

Furthermore, the notification of information is not limited to the aspects/embodiments described in the present disclosure, and may be performed using other methods. For example, the notification of information may be performed by physical layer signaling (for example, downlink control information (DCI) and uplink control information (UCI)), upper layer signaling (for example, radio resource control (RRC) signaling and medium access control (MAC) signaling), broadcast information (master information block (MIB) and system information block (SIB)), other signals, or a combination thereof. Furthermore, the RRC signaling may be referred to as an RRC message, and may be referred to as, for example, an RRC connection setup message, an RRC connection reconfiguration message, or the like.

Each aspect/embodiment described in the present disclosure may be applied to at least one of a system utilizing long term evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG) (xG (x is, for example, an integer or a decimal)), future radio access (FRA), new radio (NR), new radio access (NX), future generation radio access (FX), W-CDMA (registered trademark), GSM (registered trademark), CDMA2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), and other appropriate systems, and a next generation system which is extended, modified, generated, and stipulated based thereon. Further, a plurality of systems may be applied in combination (for example, a combination of at least one of LTE and LTE-A and 5G, and the like).

The order of the processing procedure, sequence, flowchart, and the like of each aspect/embodiment described in the present specification may be changed as long as there is no contradiction. For example, for the method described in the present disclosure, elements of various steps are presented using an example order, and are not limited to the presented particular order.

The specific operation described as being performed by the base station 10 in the present specification may be performed by an upper node thereof in some cases. In a network including one or more network nodes including the base station 10, it is obvious that various operations performed for communication with the terminal 20 may be performed by at least one of the base station 10 and other network nodes (for example, MME, S-GW, or the like is conceivable, but the present invention is not limited thereto) other than the base station 10. Although a description has been given as to a case in which there is one other network node other than the base station 10, the other network node may be a combination of a plurality of other network nodes (for example, MME and S-GW).

Information, a signal, or the like described in the present disclosure can be output from an upper layer (or a lower layer) to a lower layer (or an upper layer). Input and output may be performed via a plurality of network nodes.

The input/output information and the like may be stored in a specific location (for example, in a memory) or may be managed using a management table. The input/output information and the like can be overwritten, updated, or additionally written. The output information and the like may be deleted. The input information and the like may be transmitted to another device.

The determination in the present disclosure may be made by a value represented by one bit (0 or 1), may be made by a true/false value (Boolean: true or false), or may be made by comparison of numerical values (for example, comparison with a predetermined value).

Software, whether referred to as software, firmware, middleware, microcode, hardware description language, or other names, should be construed broadly to mean an instruction, an instruction set, a code, a code segment, a program code, a program, a subprogram, a software module, an application, a software application, a software package, a routine, a subroutine, an object, an executable file, an execution thread, a procedure, a function, and the like.

In addition, software, instructions, information, and the like may be transmitted and received via a transmission medium. For example, when software is transmitted from a website, a server, or other remote sources using at least one of a wired technology (a coaxial cable, an optical fiber cable, a twisted pair, a digital subscriber line (DSL), or the like) and a wireless technology (infrared rays, microwaves, or the like), at least one of the wired and wireless technologies is included within the definition of the transmission medium.

Information, signals, and the like described in the present disclosure may be represented using any one of a variety of different techniques. For example, data, an instruction, a command, information, a signal, a bit, a symbol, a chip, and the like which may be mentioned throughout the above description may be represented by a voltage, a current, an electromagnetic wave, a magnetic field or a particle, an optical field or a photon, or any combination thereof.

Note that the terms described in the present disclosure and the terms necessary for understanding the present disclosure may be replaced with terms having the same or similar meanings. For example, at least one of the channel and the symbol may be a signal (signaling). The signal may also be a message. In addition, a component carrier (CC) may be referred to as a carrier frequency, a cell, a frequency carrier, or the like.

The terms “system” and “network” used in the present disclosure are used interchangeably.

In addition, information, parameters, and the like described in the present disclosure may be represented using an absolute value, may be represented using a relative value from a predetermined value, or may be represented using another piece of corresponding information. For example, a radio resource may be indicated by an index.

The names used for parameters described above are not limitative names in any way. Furthermore, mathematical formulas and the like using the parameters may be different from those explicitly disclosed in the present disclosure. Since various channels (for example, PUCCH, PDCCH, and the like) and information elements can be identified by any suitable names, various names assigned to the various channels and information elements are not limitative names in any way.

In the present disclosure, terms such as “base station (BS)”, “radio base station”, “base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” can be used interchangeably. The base station may also be referred to as a macro cell, a small cell, a femto cell, a pico cell, or the like.

The base station may accommodate one or more (for example, three) cells. When the base station accommodates a plurality of cells, an entire coverage area of the base station may be divided into a plurality of smaller areas, and each smaller area may also provide a communication service by a base station subsystem (for example, a small base station for indoor use (remote radio head (RRH)). The term “cell” or “sector” refers to a part or the whole of a coverage area of at least one of the base station and the base station subsystem that performs communication service in the coverage.

In the present disclosure, the transmission of information from the base station to the terminal may be read as the base station instructing the terminal to perform control and operation based on the information.

In the present disclosure, terms such as “mobile station (MS)”, “user terminal”, “user equipment (UE)”, and “terminal” can be used interchangeably.

The mobile station may also be referred to, by those skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

At least one of the base station and the mobile station may be referred to as a transmission device, a reception device, a communication device, or the like. Note that at least one of the base station and the mobile station may be a device mounted on a mobile object, the mobile object itself, or the like. The mobile object may be a vehicle (for example, a car, an airplane, or the like), a mobile object which is movable without human intervention (for example, a drone, a self-driving vehicle, or the like), or a robot (manned type or unmanned type). Note that at least one of the base station and the mobile station includes a device which does not necessarily move during communication operation. For example, at least one of the base station and the mobile station may be an Internet of Things (IoT) device such as a sensor.

In addition, the base station in the present disclosure may be replaced with the user terminal. For example, each aspect/embodiment of the present disclosure may be applied to a configuration in which communication between the base station and the user terminal is replaced with communication between a plurality of terminals 20 (for example, may be referred to as device-to-device (D2D), vehicle-to-everything (V2X), or the like). Here, the terminal 20 may have a function of the base station 10 described above. In addition, words such as “upstream” and “downstream” may be replaced with words corresponding to inter-terminal communication (for example, “side”). For example, an uplink channel, a downlink channel, and the like may be replaced with a side channel.

Similarly, the user terminal in the present disclosure may be replaced with the base station. Here, the base station may have a function of the user terminal described above.

The terms “deciding” and “determining” used in the present disclosure may encompass a wide variety of actions. The terms “deciding” and “determining” may include considering, as “deciding” and “determining”, what has been, for example, judged, calculated, computed, processed, derived, investigated, searched (looking up, search, inquiry) (for example, searched in a table, a database, or another data structure), and ascertained. Furthermore, “deciding” and “determining” may include considering, as “deciding” and “determining”, what has been received (for example, receiving information), transmitted (for example, transmitting information), inputting, outputting, and accessed (for example, accessing data in a memory). In addition, “deciding” and “determining” may include considering, as “deciding” and “determining”, what has been resolved, selected, chosen, established, compared, and the like. That is, “deciding” and “determining” may include considering some operations as being “decided” or “determined”. Further, “deciding (determining)” may be replaced with “assuming”, “expecting”, “considering”, or the like.

The terms “connected”, “coupled”, or any variation thereof mean any direct or indirect connection or coupling between two or more elements, and one or more intermediate elements may exist between two elements which are “connected” or “coupled” to each other. The coupling or connection between the elements may be physical, logical, or a combination thereof. For example, “connection” may be replaced with “access”. As used in the disclosure, two elements can be considered to be “connected” or “coupled” to each other using at least one of one or more wires, cables, and printed electric connections, and as some non-limiting and non-inclusive examples, using electromagnetic energy having wavelengths in a radio frequency domain, a microwave region, and a light (both visible and invisible) region, and the like.

The reference signal may be abbreviated as RS, or may be referred to as a pilot according to an applied standard.

As used in the disclosure, the phrase “based on” does not mean “based only on”, unless explicitly stated otherwise. In other words, the description “based on” means both “based only on” and “based at least on”.

Any reference to elements using designations such as “first”, “second”, and the like as used in the present disclosure does not generally limit the amount or order of the elements. Such designations may be used in the present disclosure as a convenient way to distinguish between two or more elements. Thus, references to first and second elements do not imply that only two elements may be employed or that the first element must in any way precede the second element.

The “means” in the configuration of each device described above may be replaced with a “unit”, a “circuit”, a “device”, or the like.

When the present disclosure uses the terms “include”, “including”, and variations thereof, the terms are intended to be inclusive in a manner similar to the term “comprising”. Furthermore, the term “or” used in the present disclosure is intended not to be an exclusive OR.

A radio frame may be configured with one or more frames in a time domain. Each of one or more frames in the time domain may be referred to as a sub-frame. The sub-frame may be further configured with one or more slots in the time domain. The sub-frame may be a fixed time length (for example, 1 ms) which is independent of numerology.

The numerology may be a communication parameter applied to at least one of transmission and reception of a signal or a channel. The numerology may indicate at least one of, for example, a sub-carrier spacing (SCS), a bandwidth, a symbol length, a cyclic prefix length, a transmission time interval (TTI), the number of symbols per TTI, a radio frame configuration, a particular filtering operation performed by a transceiver in the frequency domain, a particular windowing operation performed by the transceiver in the time domain, and the like.

The slot may be configured with one or a plurality of symbols (an orthogonal frequency division multiplexing (OFDM) symbol, a single carrier frequency division multiple access (SC-FDMA) symbol, and the like) in the time domain. The slot may be a time unit based on the numerology.

The slot may include a plurality of mini-slots. Each mini-slot may be configured with one or more symbols in the time domain. Further, the mini-slot may be referred to as a sub-slot. The mini-slot may be configured with a smaller number of symbols than the slot. PDSCH (or PUSCH) transmitted in a time unit larger than the mini-slot may be referred to as a PDSCH (or PUSCH) mapping type A. PDSCH (or PUSCH) transmitted using the mini-slot may be referred to as a PDSCH (or PUSCH) mapping type B.

Each of the radio frame, the sub-frame, the slot, the mini-slot, and the symbol represents a time unit when a signal is transmitted. Different names respectively corresponding to the radio frame, the sub-frame, the slot, the mini-slot, and the symbol may be used.

For example, one sub-frame may be referred to as a transmission time interval (TTI), a plurality of consecutive sub-frames may be referred to as a TTI, and one slot or one mini-slot may be referred to as a TTI. That is, at least one of the sub-frame and the TTI may be a sub-frame (1 ms) in existing LTE, a period of time shorter than 1 ms (for example, 1 to 13 symbols), or a period of time longer than 1 ms. Note that the unit representing the TTI may be referred to as the slot, the mini-slot, or the like instead of the sub-frame.

Here, the TTI refers to, for example, a minimum time unit of scheduling in wireless communication. For example, in the LTE system, the base station performs scheduling of allocating radio resources (frequency bandwidth, transmission power, and the like that can be used in each terminal 20) to each terminal 20 in units of TTIs. Note that the definition of the TTI is not limited thereto.

The TTI may be a transmission time unit such as a channel coded data packet (a transport block), a code block, or a code word, or may be a processing unit such as scheduling or link adaptation. Note that, when a TTI is given, a time interval (for example, the number of symbols) in which the transport block, the code block, the code word, or the like is actually mapped may be shorter than the TTI.

Note that, when one slot or one mini-slot is referred to as the TTI, one or more TTIs (that is, one or more slots or one or more mini-slots) may be the minimum time unit of scheduling. Furthermore, the number of slots (the number of mini-slots) configuring the minimum time unit of the scheduling may be controlled.

A TTI with a time length of 1 ms may be referred to as a general TTI (TTI in LTE Rel. 8 to 12), a normal TTI, a long TTI, a general sub-frame, a normal sub-frame, a long sub-frame, a slot, or the like. A TTI shorter than the general TTI may be referred to as a shortened TTI, a short TTI, a partial TTI (or fractional TTI), a shortened sub-frame, a short sub-frame, a mini-slot, a sub-slot, a slot, or the like.

Note that the long TTI (for example, the general TTI, the sub-frame, or the like) may be replaced with a TTI having a time length exceeding 1 ms, and the short TTI (for example, the shortened TTI or the like) may be replaced with a TTI having a TTI length less than the TTI length of the long TTI and a length of 1 ms or more.

The resource block (RB) is a resource allocation unit in the time domain and the frequency domain, and may include one or a plurality of consecutive sub-carriers in the frequency domain. The number of sub-carriers included in the RB may be the same regardless of the numerology, and for example, may be 12. The number of sub-carriers included in the RB may be determined based on the numerology.

In addition, the time domain of the RB may include one or more symbols, and may be a length of one slot, one mini-slot, one sub-frame, or one TTI. Each of one TTI, one sub-frame, and the like may be configured with one or more resource blocks.

Note that one or a plurality of RBs may be referred to as a physical resource block (PRB), a sub-carrier group (SCG), a resource element group (REG), a PRB pair, an RB pair, or the like.

Furthermore, the resource block may include one or a plurality of resource elements (REs). For example, one RE may be a radio resource area of one sub-carrier and one symbol.

A bandwidth part (BWP) (which may also be referred to as a partial bandwidth or the like) may represent a subset of contiguous common resource blocks (common RBs) for a numerology in a carrier. Here, the common RB may be specified by an index of the RB based on the common reference point of the carrier. The PRB may be defined by a certain BWP and numbered within the BWP.

The BWP may include a BWP for UL (UL BWP) and a BWP for DL (DL BWP). One or a plurality of BWPs may be set in one carrier for the terminal 20.

At least one of the set BWPs may be active, and the terminal 20 may not assume that a predetermined signal/channel is transmitted and received outside the active BWPs. Note that a “cell”, a “carrier”, and the like in the present disclosure may be replaced with “BWP”.

The above-described structures such as the radio frame, the sub-frame, the slot, the mini-slot, and the symbol are merely examples. For example, the number of sub-frames included in the radio frame, the number of slots per subframe or radio frame, the number of mini-slots included in the slot, the number of symbols and RBs included in the slot or the mini-slot, the number of sub-carriers included in the RB, the number of symbols in the TTI, a symbol length, a cyclic prefix (CP) length, and the like can be variously changed.

In the present disclosure, for example, when articles such as a, an, and the in English are added by translation, the present disclosure may include a case in which a noun following the articles is a plural form.

In the present disclosure, the term “A and B are different” may mean “A and B are different from each other”. Note that the term may mean that “A and B are different from C”. Terms such as “separated” and “coupled” may be interpreted in the same manner as “different”.

Each aspect/embodiment described in the present disclosure may be used alone, used in combination, or used by being switched with execution. Furthermore, notification of predetermined information (for example, notification of “being X”) is not limited to being performed explicitly, and may be performed implicitly (for example, the predetermined information is not notified).

Although the present disclosure has been described in detail above, it is apparent to those skilled in the art that the present disclosure is not limited to the embodiments described in the present disclosure. The present disclosure can be implemented as modifications and variations without departing from the spirit and scope of the present disclosure defined by the claims. Therefore, description of the present disclosure is given for the purpose of illustration and does not have any restrictive meaning to the present disclosure.

### REFERENCE SIGNS LIST

10 base station
110 transmission unit
120 reception unit
130 setting unit
140 control unit
20 terminal
210 transmission unit
220 reception unit
230 setting unit
240 control unit
1001 processor
1002 storage device
1003 auxiliary storage device
1004 communication device
1005 input device
1006 output device
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 rotation speed sensor
2023 air pressure sensor
2024 vehicle speed sensor
2025 acceleration sensor
2026 brake pedal sensor
2027 shift lever sensor
2028 object detection sensor
2029 accelerator pedal sensor
2030 driving assistance system unit
2031 microprocessor
2032 memory (ROM, RAM)
2033 communication port (IO port)

1. A terminal comprising:
a control unit configured to determine frequency hopping outside a Bandwidth Part (BWP) or frequency hopping inside the BWP to be applied to a signal related to positioning;
a transmission unit configured to transmit, to a base station, the signal related to positioning; and
a reception unit configured to receive, from the base station, at least position information calculated based on the signal related to positioning.

2. The terminal according to claim 1, wherein the control unit sets a periodic gap or a gap only at a timing necessary for radio retuning when the signal related to positioning is transmitted outside the BWP.

3. The terminal according to claim 2, wherein the control unit assumes different gap lengths for radio retuning based on terminal capabilities.

4. The terminal according to claim 2, wherein the control unit determines whether to transmit the signal related to positioning based on a priority when a gap for the radio retuning overlaps with another signal.

5. The terminal according to claim 1, wherein, when applying frequency hopping inside the BWP, the control unit applies the frequency hopping in units of resource blocks or in units of resource elements to the signal related to positioning.

6. A communication method executed by a terminal, the communication method comprising:
determining frequency hopping outside a Bandwidth Part (BWP) or frequency hopping inside the BWP to be applied to a signal related to positioning; and
transmitting the signal related to positioning to a base station; and
receiving, from the base station, at least position information calculated based on the signal related to positioning.
